(19) United States
(12) Patent Application Publication
(10) Pub. No.: US 2022/0066219 A1
(43) Pub. Date: Mar. 3, 2022

(54) VIRTUAL IMAGE DISPLAY DEVICE AND OPTICAL UNIT

(71) Applicant: SEIKO EPSON CORPORATION, Tokyo (JP)

(72) Inventor: Atsushi SAITO, Chino-shi (JP)

(73) Assignee: SEIKO EPSON CORPORATION, Tokyo (JP)

(21) Appl. No.: 17/459,729

(22) Filed: Aug. 27, 2021

(30) Foreign Application Priority Data
Aug. 28, 2020 (JP) 2020-144248

(51) Int. Cl. G02B 27/01; G02B 5/26; G02B 5/18; G02B 5/32

(52) U.S. Cl. CPC G02B 27/0172; G02B 5/26; G02B 5/1861; G02B 2027/0178; G02B 5/1814; G02B 5/1842; G02B 5/32

(57) ABSTRACT

A virtual image display device includes an imaging light generation device, and an optical unit including a concave transmission mirror provided with a partial reflection film, the optical unit being configured to form a virtual image with the imaging light emitted from the imaging light generation device, wherein the optical unit includes a reflection type diffraction element disposed on an external side of the partial reflection film, the reflection type diffraction element being configured to diffract the imaging light so that the imaging light is deviated from an optical path passing through the concave transmission mirror.

The present application is based on, and claims priority from JP Application Serial Number 2020-144248, filed Aug. 28, 2020, the disclosure of which is hereby incorporated by reference herein in its entirety.

### BACKGROUND

### 1. Technical Field

The present disclosure relates to a see-through type virtual image display device and an optical unit, and particularly relates to a type of a virtual image display device and an optical unit that allow imaging light to enter a concave transmission mirror and observe reflected light from the concave transmission mirror.

### 2. Related Art

As a virtual image display device, a so-called bird bath type device including a transmissive reflection surface and a concave transmission mirror is known (see JP-A-2020-008749). JP-A-2020-008749 describes a feature wherein the imaging light incident on a prism member provided with the transmissive reflection surface is guided by total internal reflection toward the transmissive reflection surface on the total reflection surface of the prism member, as well as the imaging light is reflected by the transmissive reflection surface toward the concave transmission mirror disposed in front of the prism member.

In the virtual image display device of JP-A-2020-008749, the imaging light is emitted to a front face, and therefore, there is a problem in that the image being displayed is visible from the outside.

### SUMMARY

A virtual image display device according to one aspect of the present disclosure includes an imaging light generation device, and an optical unit including a concave transmission mirror provided with a partial reflection film, the optical unit being configured to form a virtual image with the imaging light emitted from the imaging light generation device, wherein the optical unit includes a reflection type diffraction element disposed on an external side of the partial reflection film, the reflection type diffraction element being configured to diffract the imaging light so that the imaging light is deviated from an optical path passing through the concave transmission mirror.

### BRIEF DESCRIPTION OF THE DRAWINGS

FIG. 1 is an external view illustrating a mounted state of a virtual image display device of a first exemplary embodiment.

FIG. 2A is a side cross-sectional view illustrating the virtual image display device of FIG. 1.

FIG. 2B is a partially enlarged side cross-sectional view illustrating a concave transmission mirror, etc.

FIG. 3 is a diagram illustrating functions of a reflection type diffraction element incorporated into the concave transmission mirror.

FIG. 4 is a side cross-sectional view illustrating a virtual image display device of a modification example.

FIG. 5 is a side cross-sectional view illustrating a device of a second exemplary embodiment.

FIG. 6 is a diagram illustrating functions of a reflection type diffraction element etc. in the device of FIG. 5.

FIG. 7 is a side cross-sectional view illustrating a virtual image display device of a modification example.

FIG. 8 is a side cross-sectional view illustrating a device of a third exemplary embodiment.

FIG. 9 is a diagram illustrating functions of a reflection type diffraction element etc. in the device of FIG. 8.

FIG. 10 is a side cross-sectional view illustrating a fourth exemplary embodiment.

FIG. 11 is a perspective view illustrating a fifth exemplary embodiment.

FIG. 12 is a flat surface cross-sectional view illustrating a virtual image display device of a sixth exemplary embodiment.

FIG. 13 is a flat surface cross-sectional view illustrating a virtual image display device of a modification example.

FIG. 14 is a front view illustrating a virtual image display device of a seventh exemplary embodiment.

### DESCRIPTION OF EXEMPLARY EMBODIMENTS

### First Exemplary Embodiment

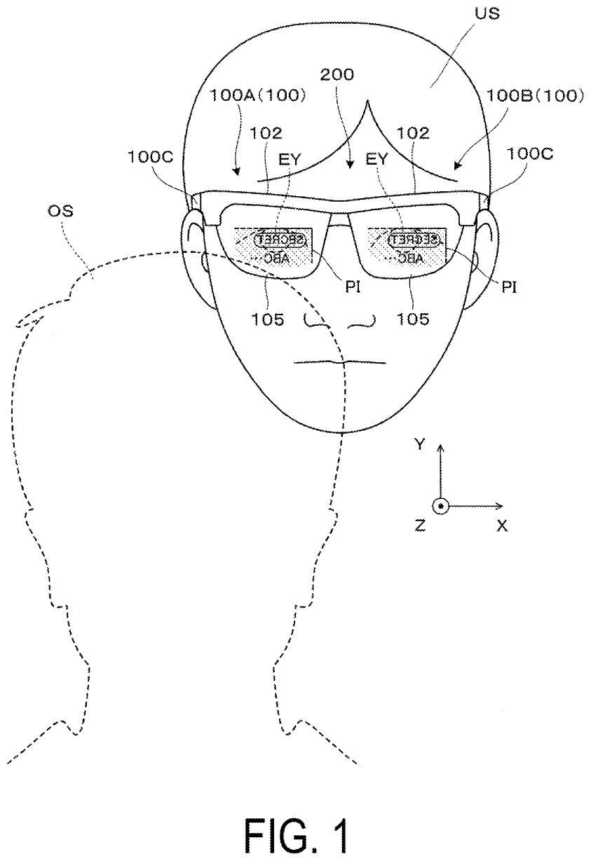

Hereinafter, a virtual image display device according to a first embodiment of the present disclosure and an optical unit incorporated therein will be described with reference to FIGS. 1 to 4, etc.

FIG. 1 is a diagram illustrating a mounting state of a head-mounted display (hereinafter, also referred to as “HMD”) 200. The HMD 200 causes an observer or wearer US wearing the HMD 200 to recognize an image as a virtual image. In FIG. 1, etc., X, Y, and Z are an orthogonal coordinate system, where an X direction corresponds to a lateral direction in which both eyes EY of the observer or wearer US wearing the HMD 200 or the virtual image display device 100 are aligned, a Y direction corresponds to an upward direction orthogonal to the lateral direction in which both eyes EY of the wearer US are aligned, and a Z direction corresponds to a front direction of the wearer US or a front face direction. The ±Y direction is parallel to a vertical axis or a vertical direction.

The HMD 200 includes a first display device 100A for the right eye, a second display device 100B for the left eye, and a pair of temple support devices 100C for supporting the display devices 100A and 100B. The first display device 100A includes a display driving unit 102 disposed at an upper portion, and an appearance member 105 that has a spectacle lens shape and covers the front of the eye. Similarly, the second display device 100B includes a display driving unit 102 disposed at an upper portion, and an appearance member 105 that has a spectacle lens shape and covers the front of the eye. The support device 100C supports a top end side of the appearance member 105 via the display driving unit 102. The first display device 100A and the second display device 100B are optically inverted from left to right. Hereinafter, the first display device 100A for the right eye will be described as the representative virtual image display device 100.

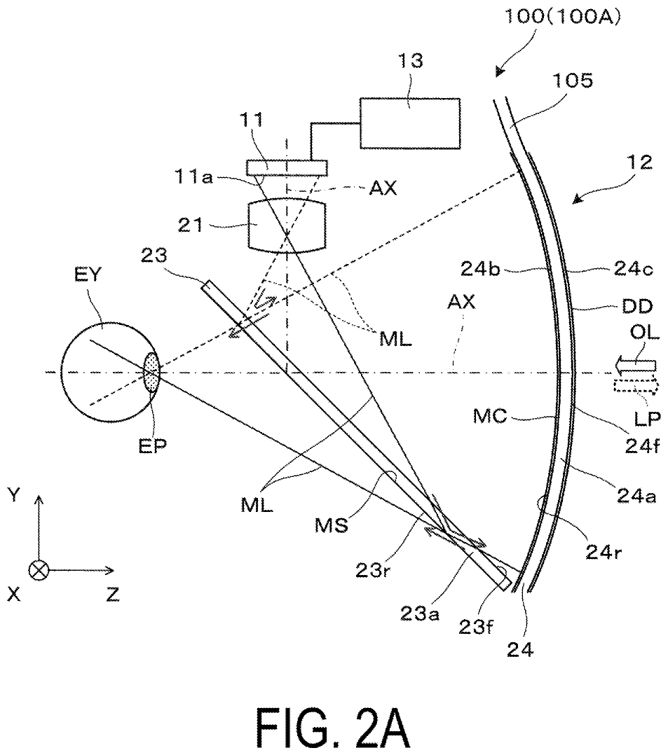

A virtual image display device 100, which is the display device 100A for the right eye, will be described with reference to FIG. 2A. The virtual image display device 100 includes an imaging light generation device 11, an optical unit 12, and a display control circuit 13. However, in the present specification, a device excluding the display control circuit 13 is also referred to as a virtual image display device 100 in terms of achieving optical functions. The imaging light generation device 11 and the display control circuit 13 are supported within an outer frame of the display driving unit 102 illustrated in FIG. 1. A portion of the optical unit 12 is also supported within the outer frame of the display driving unit 102.

The imaging light generation device 11 is a self-emitting display device. The imaging light generation device 11 is, for example, an organic EL (Organic Electro-Luminescence) display, and forms a color still image or a moving image on a two-dimensional display surface 11a. The imaging light generation device 11 is driven by the display control circuit 13 to perform display operation. The imaging light generation device 11 is not limited to organic EL displays, and can be replaced with display devices using inorganic ELs, LED arrays, organic LEDs, laser arrays, quantum dot light-emitting elements, etc. The imaging light generation device 11 is not limited to the self-emitting imaging light generation device, and may include an LCD or another light modulating element, and may form an image by illuminating the light modulating element with a light source such as a backlight. As the imaging light generation device 11, a LCOS (Liquid crystal on silicon, where LCoS is a registered trademark), a digital micro-mirror device, etc. may be used instead of the LCD.

The optical unit 12 is an imaging system including a projection lens 21, a transmission inclined mirror 23, and a concave transmission mirror 24. The optical unit 12 images imaging light ML emitted from the imaging light generation device 11 as a virtual image. In the optical unit 12, an optical path from the imaging light generation device 11 to the projection lens 21 is located on the upper side of the transmission inclined mirror 23. More specifically, the imaging light generation device 11 and the projection lens 21 are disposed in a space interposed between an inclined plane in which the transmission inclined mirror 23 is extended and a vertical surface in which an upper end of the concave transmission mirror 24 is extended upward.

The projection lens 21 is held within the outer frame of the display driving unit 102 illustrated in FIG. 1. The projection lens 21 converges the imaging light ML emitted from the imaging light generation device 11 to image the imaging light ML, and then enters the imaging light ML into the transmission inclined mirror 23. Although detailed explanation is omitted, the projection lens 21 may include one or more lenses and includes a spherical lens or an aspheric lens, but may also include a free-form lens.

The transmission inclined mirror 23 is a flat plate shaped optical member, and has a planar reflection surface MS. The word of transmission in the transmission inclined mirror 23 means that light is partially transmitted. The transmission inclined mirror 23 is formed of a metal film or a dielectric multilayer film as a transmissive reflection film on an inner side surface 23r of a parallel flat plate 23a having a uniform thickness and transparency. Such a transmissive reflection film functions as a planar reflection surface MS. The reflectance and the transmittance of the planar reflection surface MS are set to, for example, approximately 50%. An antireflection film can be formed at an outer side surface 23f of the parallel flat plate 23a.

The transmission inclined mirror 23 bends an optical axis AX in a direction orthogonal to the optical axis AX in the YZ plane. The imaging light ML traveling downward through the projection lens 21 is bent in the +Z direction, that is the front direction, by the transmission inclined mirror 23, and is incident on the concave transmission mirror 24. The transmission inclined mirror 23 is disposed between the concave transmission mirror 24 and the exit pupil EP on which the eye EY or a pupil is located. The transmission inclined mirror 23 covers the exit pupil EP. The transmission inclined mirror 23 can be fixed directly or indirectly to the outer frame of the display driving unit 102 illustrated in FIG. 1, and can have a configuration in which the arrangement relationship with respect to the concave transmission mirror 24 etc. is appropriately set.

The concave transmission mirror 24 is an optical member having a concave shape toward the exit pupil EP. The word of transmission in the concave transmission mirror 24 means that light is partially transmitted. The concave transmission mirror 24 has a light convergence function as a function for imaging, and performs collimation by reflecting the imaging light ML that is reflected by the transmission inclined mirror 23 and travels forward while being diverging. The imaging light ML is returned to the transmission inclined mirror 23 by the concave transmission mirror 24, and is partially transmitted through the transmission inclined mirror 23 and is collected into the exit pupil EP. That is, the concave transmission mirror 24 reflects the imaging light ML so that the imaging light ML is collected into the exit pupil EP while being collimated by a partial reflection film 24b that is concave inside. At this time, the imaging light ML is incident from a direction close to normal to the entire portion of a partial reflection surface MC of the concave transmission mirror 24, and then reflected, whereby the optical symmetry thereof is high. A plate shaped body 24a of the concave transmission mirror 24 has a uniform thickness while being curved. The plate shaped body 24a has transparency that allows light to be transmitted substantially without loss. A metal film or a dielectric multilayer film is formed as a partial reflection film on an inner surface 24r of the plate shaped body 24a. Such a partial reflection film functions as a concave partial reflection surface MC. The reflectance and transmittance of the partial reflection surface MC are set to, for example, approximately 20˜50%. The partial reflection surface MC ensures optical transparency of the concave transmission mirror 24 with respect to external light OL etc. A reflection type diffraction layer that diffracts the imaging light ML is formed at an outer side surface 24f of the plate shaped body 24a. Such a reflection type diffraction layer functions as a reflection type diffraction element DD. The reflection type diffraction element DD ensures blocking of the concave transmission mirror 24 with respect to the imaging light ML. The reflection type diffraction element DD exerts functions thereof by being disposed on the external side of the partial reflection film that forms the partial reflection surface MC. Here, the reflection type diffraction element DD is formed as part of the concave transmission mirror 24 so that a surface on an external side of the concave transmission mirror 24 is formed. In this case, a number of parts can be reduced and an increase in the weight and price of the device can be suppressed. Note that an antireflection film can be formed at the surface of the reflection type diffraction element DD.

The partial reflection surface MC may be a free curved surface, while it is easy to have the target reflection characteristics of the partial reflection surface MC by providing an axisymmetric curved surface such as a spherical surface or an aspheric surface.

The concave transmission mirror 24 is incorporated to constitute a portion of the transmissive appearance member 105 illustrated in FIG. 1. In other words, by providing a plate member having transparency or not having transparency to the periphery of the concave transmission mirror 24, the appearance member 105 including the concave transmission mirror 24 can be provided. The appearance member 105 is not limited to a spectacle lens shape, and can have various contours or appearance.

The concave transmission mirror 24 or plate shaped body 24a preferably has a thickness of 1 mm or greater in order to ensure shape strength, but preferably has a thickness of 2 mm or less in terms of weight reduction. The plate shaped body 24a is formed from a resin material having optical transparency, for example, by injection molding.

In describing the optical path, the imaging light ML from the imaging light generation device 11 is incident on the transmission inclined mirror 23 via the projection lens 21. An intermediate image (not illustrated), which is an appropriately enlarged image formed at the display surface 11a of the imaging light generation device 11, may be formed between the transmission inclined mirror 23 and the projection lens 21. The imaging light ML incident on the transmission inclined mirror 23 and reflected by the planar reflection surface MS by, for example, approximately 50%, is incident on the concave transmission mirror 24 and is reflected by the partial reflection surface MC, for example, at a reflectance of approximately 50% or less. The imaging light ML reflected by the concave transmission mirror 24 is transmitted through the transmission inclined mirror 23, and is incident on the exit pupil EP on which the eye EY or the pupil of the wearer US is located. Here, the exit pupil EP is an eye point of the optical unit 12 assuming that the eye EY is located. Light from each point of the display surface 11a of the imaging light generation device 11 is incident to be collected at a certain point of the exit pupil EP at an angle that allows for the observation of the virtual image. The external light OL passing through the concave transmission mirror 24 is also incident on the exit pupil EP. In other words, the wearer US wearing the HMD 200 can observe the virtual image with the imaging light ML by overlaying the virtual image on the external image.

Note that the concave transmission mirror 24 causes the external light OL to pass therethrough, but also causes the imaging light ML to pass therethrough, which result in the passing light LP in front of the concave transmission mirror 24. If the intensity of the passing light LP is large, a third party OS present around the wearer US can observe a portion PI of the image displayed on the display surface 11a of the imaging light generation device 11 (see FIG. 1). In contrast, in the present exemplary embodiment, as described below, in the concave transmission mirror 24, the reflection type diffraction element DD is provided on the external side of the partial reflection film 24b to suppress the generation of the passing light LP, whereby the portion PI of the image is prevented from becoming observable by the third party OS.

Hereinafter, the structure of the concave transmission mirror 24 will be described below with reference to FIG. 2b. The concave transmission mirror 24 includes a plate shaped body 24a that is a support for maintaining an overall shape, a partial reflection film 24b formed inside the plate shaped body 24a (the exit pupil EP side in FIG. 2), and a 24c formed on an external side of the plate shaped body 24a. The partial reflection film 24b functions as a partial reflection surface MC that is concave inside, and reflects the imaging light ML at a prescribed reflectance. At this time, the partial reflection film 24b reflects the imaging light ML of the visible wavelength range substantially uniformly regardless of the wavelength. As the reflection type diffraction element DD that is convex outward, the reflection type diffraction layer 24c diffracts leakage light LE, which is the imaging light ML that has passed through the partial reflection film 24b, so that the leakage light LE is deviated from a linear optical path. The reflection type diffraction layer 24c is a curved surface similar to the partial reflection film 24b. The plate shaped body 24a has a substantially uniform thickness. The reflection type diffraction layer 24c bends the imaging light ML or the leakage light LE so that the imaging light ML or the leakage light LE is deviated from the linear optical path passing through the concave transmission mirror 24. Deflecting the leakage light LE away from the linear optical path means that the optical path of the imaging light ML or the leakage light LE is directed in another direction so as not to travel in the front face direction of the external environment. The reflection type diffraction element DD can be utilized to bend the leakage light LE to reflect obliquely. When the leakage light LE is incident substantially perpendicularly on the reflection type diffraction element DD, the angle by which the leakage light LE is bent is 90° or greater with respect to the original direction, but 135° or less from the original direction so as not to be close to specular reflection. Specifically, the reflection type diffraction layer 24c bends the imaging light ML or the leakage light LE so that they are reflected downward with respect to the linear optical path passing through the concave transmission mirror 24. Here, the “downward” refers to the inner side or the exit pupil EP side of the reflection type diffraction layer 24c in a conical region extending below 45° or less with respect to the lower side of the incident point or the −Y side, along an intersection line between the tangent plane of the reflection type diffraction layer 24c at the incident point of the leakage light LE and a surface parallel to the YZ plane. Diffraction light LD bent in the downward direction by the reflection type diffraction layer 24c propagates within the plate shaped body 24a of the concave transmission mirror 24 while being reflected by the outer side surface 24f or the inner surface 24r, and is emitted from the end portion. Alternatively, the diffraction light LD is refracted by the outer side surface 24f or the inner surface 24r of the concave transmission mirror 24 and is emitted to the outside. Meanwhile, the diffraction light LD emitted out of the concave transmission mirror 24 is attenuated by each portion of the concave transmission mirror 24, and the exit direction thereof does not have regularity that is influenced by the original imaging light ML. Accordingly, even in the presence of the leakage light LE, the situation can be avoided wherein most of the leakage light LE is diffracted by the reflection type diffraction layer 24c, and wherein the virtual image or real image influenced by the display image formed at the display surface 11a of the imaging light generation device 11 is formed, which is observable by a third party. If the reflection type diffraction layer 24c is not present, the leakage light LE of the imaging light ML travels through the concave transmission mirror 24 and is emitted to the external side, and a portion of the virtual image or real image influenced by the display image formed at the display surface 11a of the imaging light generation device 11 can be observed to a third party. Note that an absorbent material for absorbing the diffraction light LD can be applied or adhered to the edge of the lower end of the concave transmission mirror 24.

The reflection type diffraction layer 24c or the reflection type diffraction element DD includes an R diffraction layer 41a that diffracts red R light, a G diffraction layer 41b that diffracts green G light, and a B diffraction layer 41c that diffracts blue B light as the three diffraction elements corresponding to the three colors. The R diffraction layer 41a diffracts the R component LE1 of the leakage light LE, deflects the component away from the original optical path, and forms a red wavelength diffraction light LD emitted in the downward direction. The G diffraction layer 41b diffracts the G component LE2 of the leakage light LE, deflects the component away from the original optical path, and forms a green wavelength diffraction light LD emitted in the downward direction. The B diffraction layer 41c diffracts the B component LE3 of the leakage light LE, deflects the component away from the original optical path, and forms a blue wavelength diffraction light LD emitted in the downward direction. The R diffraction layer 41a, the G diffraction layer 41b, and the B diffraction layer 41c are reflection type diffraction elements, respectively. They are individually manufactured as film-shaped optical elements, joined to each other and laminated, and attached to the outer side surface 24f of the plate shaped body 24a as a whole to form the external side surface. Each of the diffraction layers 41a, 41b, and 41c is, for example, a volume hologram element. When each of the diffraction layers 41a, 41b, and 41c is a volume hologram element, the reflection type diffraction element DD includes three diffraction layers 41a, 41b, 41c as three volume hologram layers corresponding to the three colors. In this case, the diffraction layers 41a, 41b, and 41c are produced by a technique such as irradiating a film shaped storage material with object light and reference light to interfere with each other in the storage material for exposure and recording.

Note that the partial reflection film 24b need not be formed directly at the plate shaped body 24a. For example, the plate shaped body 24a may be coated with a hard coat film, and the partial reflection film 24b may be formed thereon. The reflection type diffraction layer 24c also need not be formed directly at the plate shaped body 24a or directly affixed thereon. For example, the plate shaped body 24a may be coated with a hard coat film, and the reflection type diffraction layer 24c may be formed or affixed thereon. Furthermore, the partial reflection film 24b may be embedded in the plate shaped body 24a.

The reflection type diffraction element DD need not have a three-layer structure including the R diffraction layer 41a, the G diffraction layer 41b, and the B diffraction layer 41c, but may be an element in which stripes that diffract the imaging light ML or the leakage light LE for each color of RGB may be collectively formed in a single layer. In this manner, when the RGB imaging light ML or the leakage light LE is diffracted in a single layer, it is expected that the diffraction efficiency is reduced and some drop light is generated at the peak wavelength compared to a case where the three diffraction layers 41a, 41b, 41c are incorporated therein. However, when the light intensity of such drop light is not large, it will not be easy for the third party to observe the image in the display. Conversely, the reflection type diffraction element DD may have a multilayer structure with three or more layers. For example, in addition to the diffraction layers 41a, 41b, 41c described above, a fourth diffraction layer that diffracts the imaging light ML in the wavelength range between RG and a fifth diffraction layer that diffracts the imaging light ML in the wavelength range between GB can be added to obtain a reflection type diffraction element DD having a five-layer structure. In this case, the imaging light ML used in the range of wavelengths between RG or between GB can be prevented from being emitted to the external side of the concave transmission mirror 24 and being observable to the third party.

In the above, the reflection type diffraction layer 24c is configured to propagate the imaging light ML or the leakage light LE to be reflected or bent downward so that the imaging light ML or the leakage light LE is deviated from the linear optical path passing through the concave transmission mirror 24. Meanwhile, the imaging light ML or the leakage light LE may be propagated to be reflected or bent upward from the original optical path. Here, the “upward” refers to the inner side or the exit pupil EP side of the reflection type diffraction layer 24c in a conical region extending above 45° or less with respect to the upper side of the incident point or the +Y side, along an intersection line between the tangent plane of the reflection type diffraction layer 24c at the incident point of the leakage light LE and a surface parallel to the YZ plane. In this case, an absorbent material for absorbing the diffraction light LD can be applied or adhered to the edge of the upper end of the concave transmission mirror 24. The three diffraction layers 41a, 41b, and 41c need not diffract each color light of RGB in the same direction. One of the colors may be diffracted upward and the remaining color may be diffracted downward. The three diffraction layers 41a, 41b, and 41c need not have the same diffraction efficiency. For example, the G diffraction layer 41b having a high relative luminous efficiency can be relatively increased in diffraction efficiency.

The reflection type diffraction layer 24c may propagate the imaging light ML or the leakage light LE to be reflected or bent in the left-right lateral direction or the oblique direction of the concave transmission mirror 24. Here, the “lateral direction” refers to the inner side or the exit pupil EP side of the reflection type diffraction layer 24c in a conical region within 45° or less with respect to the ±X side of the incident point, along an intersection line between the tangent plane of the reflection type diffraction layer 24c at the incident point of the leakage light LE and a surface parallel to the YZ plane. In this case, an absorbent material for absorbing the diffraction light LD can be applied or adhered to the edge of the right end or the left end of the concave transmission mirror 24. However, when the diffraction angle of the leakage light LE increases in the lateral direction, the proportion of the diffraction light LD emitted from the inner surface of the concave transmission mirror 24 toward the side of the concave transmission mirror 24 is increased. To avoid this, it may also be desirable to provide a light shielding member that overhangs the face side at the left and right ends of the concave transmission mirror 24 so that the virtual image cannot be observed by the third party located on the side of the wearer US. Note that the oblique direction refers to the intermediate direction between the lateral direction and the vertical direction. The oblique direction refers to, for example, the inner side or the exit pupil EP side of the reflection type diffraction layer 24c in an intermediate direction between the +X direction and the +Y direction, and in a conical region within 45° of the intermediate direction.

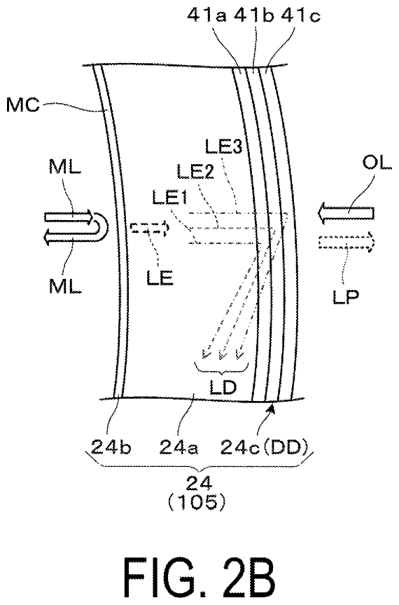

FIG. 3 is a schematic chart illustrating functions of the reflection type diffraction layer 24c or the reflection type diffraction element DD provided at the concave transmission mirror 24. In this chart, the horizontal axis indicates the wavelength and the vertical axis indicates the light intensity (arbitrary units). The wavelength characteristic W1 of the imaging light ML indicated by the solid line corresponds to the light emission characteristics of the imaging light generation device 11, and has a peak of light intensity in the wavelength range of blue B light, green G light, and red R light. The wavelength characteristic W2 indicated by the dot-dash line is a sum of the light intensity of the diffraction light LD caused by the reflection type diffraction layer 24c or the reflection type diffraction element DD and the internal absorption by the reflection type diffraction layer 24c or the reflection type diffraction element DD. The wavelength width of each peak of the diffraction light LD caused by the reflection type diffraction layer 24c or the reflection type diffraction element DD is set to be approximately ±15 nm. However, the imaging light ML at a wavelength other than the designed wavelength is also reflected with a certain efficiency and can be deviated from the optical path, although it does not reach the target angle. In addition, by having some fluctuation in the interference fringes formed in the reflection type diffraction element DD, some adjustment is possible with respect to the diffraction wavelength width, although the peak value of the diffraction efficiency decreases. As a result, the wavelength of interest to be diffracted by the reflection type diffraction element DD can be adjusted to be close to the wavelength width of the imaging light ML. The wavelength characteristics W3 indicated by the dashed line illustrates the light intensity of the imaging light ML that finally passes through the concave transmission mirror 24, that is, the passing light LP. The peak height of W3 is significantly decreased when compared to the light intensity of the original imaging light ML, and the light intensity thereof is lowered to a level close to zero especially in the wavelength range of the B light, the G light, and the R light. Note that some passing light LP is allowed between the wavelength ranges of B, G, and R light, namely in the intermediate wavelength range of BG and intermediate wavelength range of GR. Meanwhile the passage of the external light OL is also allowed, and a reliable see-through view of the external light OL is ensured, whereby a bright external image can be observed.

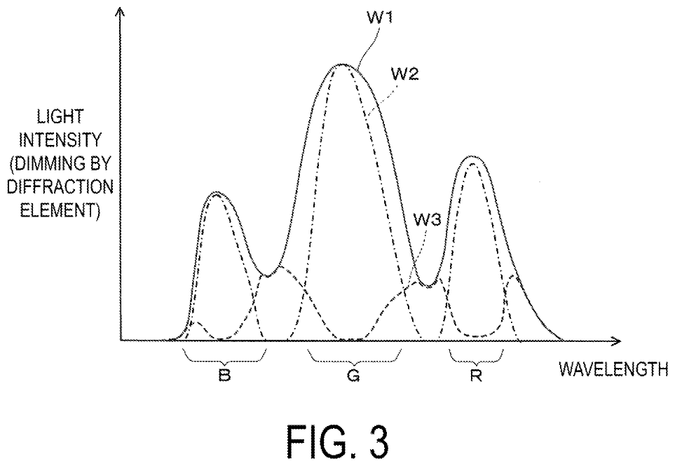

FIG. 4 is a diagram illustrating a modification example of the optical unit 12 illustrated in FIG. 2A. In this case, a cover 124 is disposed at the front face of the concave transmission mirror 24 or the appearance member 105, and the entire concave transmission mirror 24 etc. is covered by the cover 124. In this modification example, the reflection type diffraction layer 24c, which is the reflection type diffraction element DD, is formed at the cover 124 rather than the concave transmission mirror 24. In other words, the reflection type diffraction element DD is formed at the cover 124 disposed on the external side of the concave transmission mirror 24. Forming the reflection type diffraction element DD on the cover 124 facilitates manufacturing and incorporation of the reflection type diffraction element DD. The reflection type diffraction element DD or the reflection type diffraction layer 24c may be formed at the outer side surface 124f of the plate shaped body 124a as illustrated, but may be formed at the inner surface 124r. When the reflection type diffraction layer 24c is formed at the outer side surface 124f, an antireflection film can be formed at the inner surface 124r. When the reflection type diffraction layer 24c is formed at the inner surface 124r, an antireflection film can be formed at the outer side surface 124f. Note that the cover 124 can be a shade detachable to the outer frame of the display driving unit 102 illustrated in FIG. 1. At this time, the plate shaped body 124a can be formed from a light absorbing material that disperses or contains a light absorbing material, for example. The cover 124 may be flat as illustrated, but may have the same curvature as the concave transmission mirror 24. In this case, the cover 124 is a concave plate shaped body toward the concave transmission mirror 24 and the exit pupil EP. The reflection type diffraction element DD also forms a concave surface toward the concave transmission mirror 24 and the exit pupil EP.

As described above, according to the virtual image display device 100 of the first exemplary embodiment, the reflection type diffraction element DD diffracts the imaging light ML so that the imaging light ML is deviated from the optical path passing through the concave transmission mirror 24, whereby the imaging light ML emitted to the external side through the partial reflection film 24b can be suppressed, and the image in the display is made less visible from the outside, and the effect of suppressing information loss increases.

In the virtual image display device 100 of the present exemplary embodiment, the reflection type diffraction element DD diffracts the imaging light ML upward or downward. A situation where the third party is present above or below the virtual image display device 100 is unlikely to occur, and the light shielding member is easily disposed above or below the virtual image display device 100, whereby the effect of suppressing information loss can be further enhanced.

### Second Exemplary Embodiment

Hereinafter, a virtual image display device according to a second exemplary embodiment will be described. Note that the virtual image display device according the second exemplary embodiment is obtained by modifying a part of the virtual image display device according to the first exemplary embodiment, and description on common portions is omitted.

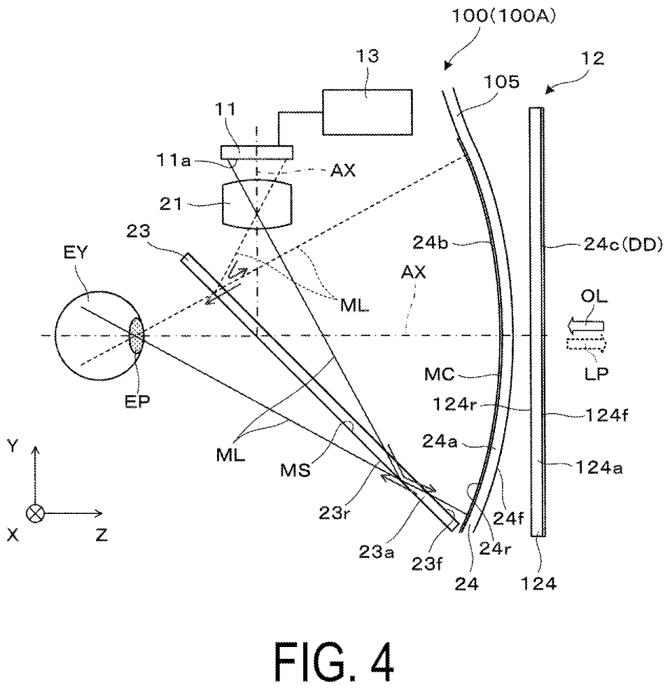

FIG. 5 is a side cross-sectional view illustrating a virtual image display device 100 of the second exemplary embodiment. In this case, a wavelength-limiting filter 51 is disposed at the display surface 11a of the imaging light generation device 11. In other words, the wavelength-limiting filter 51 is provided in association with the imaging light generation device 11. The wavelength-limiting filter 51 includes, for example, a dielectric multilayer film, and transmits light in a specific wavelength range and attenuates light outside of the specific wavelength range. The transmission characteristics of the wavelength-limiting filter 51 correspond to the wavelength characteristics of the diffraction efficiency of the reflection type diffraction layer 24c or the reflection type diffraction element DD. The wavelength-limiting filter 51 has wavelength characteristics that transmit a wavelength component of the imaging light ML that is easily diffracted by the reflection type diffraction layer 24c. In other words, the wavelength-limiting filter 51 has modified the wavelength distribution of the imaging light ML according to the wavelength characteristics of the reflection type diffraction element DD. In this case, the characteristics of the imaging light ML incident on the wavelength-limiting filter 51 are easily matched to the diffraction characteristics of the reflection type diffraction element DD, whereby the reliability of preventing information loss is enhanced.

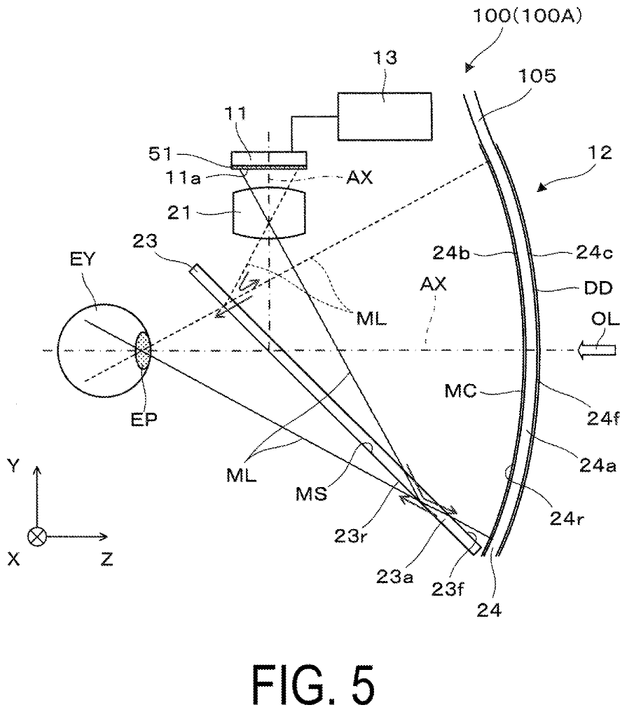

FIG. 6 is a schematic chart illustrating functions of the wavelength-limiting filter 51 and the reflection type diffraction element DD, corresponding to FIG. 3. In the example illustrated in FIG. 6, the wavelength characteristic W1 of the imaging light ML indicated by the solid line is a superimposition of the transmission characteristics of the wavelength-limiting filter 51 with the light emission characteristics or light source characteristics of the imaging light generation device 11. In other words, the wavelength-limiting filter 51 has a transmittance distribution such that the wavelength characteristic W1 illustrated in FIG. 3 is reduced to the wavelength characteristic W1 illustrated in FIG. 6. The transmission characteristics of the wavelength-limiting filter 51 can be controlled by adjusting the refractive index, film thickness, layer number, etc. of the dielectric film that constitutes the dielectric multilayer film. The wavelength characteristic W2 of the reflection type diffraction element DD illustrated by the dot-dash line is the same as that illustrated in FIG. 3, and there is no change. Accordingly, the wavelength characteristic W3 of the imaging light ML or the passing light LP that finally passes through the concave transmission mirror 24 is suppressed to a low light intensity level not only in the wavelength range of B, G, and R light, but also in the intermediate wavelength range of the BG and the intermediate wavelength range of GR. In this case, there is no light drop in the intermediate wavelength range of the BG and the intermediate wavelength range of GR, whereby the effect of suppressing information loss such as privacy protection is enhanced. In addition, the device of the present exemplary embodiment has the advantage that the wavelength width of the light used for the imaging light ML is narrowed, and the color gamut of the color triangle can be broadly taken. However, the light intensity reaching the eye EY is reduced, so the light utilization efficiency is reduced.

In the example illustrated in FIG. 6, in the wavelength characteristic W1 of the imaging light ML, the wavelength-limiting filter 51 reduces the light source wavelength width of each color of RGB to the same extent as the diffraction wavelength width for each color of the reflection type diffraction element DD. Although not illustrated in the drawings, in the wavelength characteristic W1 of the imaging light ML, the light source wavelength width of each color of RGB may be narrower than the diffraction wavelength width for each color of the reflection type diffraction element DD. In this case, the passing light LP can be substantially eliminated, whereby the effect of suppressing information loss is high.

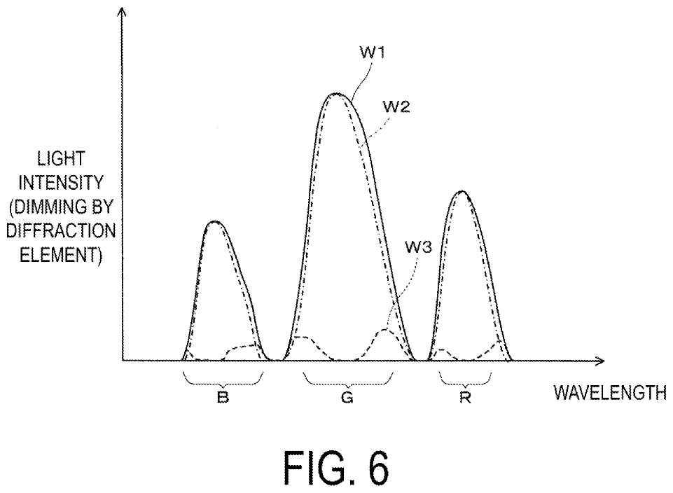

FIG. 7 is a diagram illustrating a modification example of the optical unit 12 illustrated in FIG. 6. In this case, a wavelength-limiting filter 151 is disposed inside the reflection type diffraction layer 24c or the reflection type diffraction element DD of the concave transmission mirror 24. As described in more detail, in the concave transmission mirror 24, the wavelength-limiting filter 151 is disposed between the plate shaped body 24a, which is a substrate, and the reflection type diffraction element DD. The wavelength-limiting filter 151 has the same wavelength characteristics as the wavelength-limiting filter 51 incorporated in the optical unit 12 illustrated in FIG. 6. When the wavelength-limiting filter 151 is disposed inside the reflection type diffraction element DD, the light intensity reaching the eye is the same as that illustrated in

FIG. 6, but the external light OL is attenuated by the wavelength-limiting filter 151, whereby the see-through properties are decreased. Note that, although not illustrated in the drawings, the wavelength-limiting filter 151 may be disposed at the outer side surface 23f of the transmission inclined mirror 23.

### Third Exemplary Embodiment

Hereinafter, a virtual image display device according to a third exemplary embodiment will be described. Note that the virtual image display device according the third exemplary embodiment is obtained by modifying a part of the virtual image display device according to the first exemplary embodiment, and description on common portions is omitted.

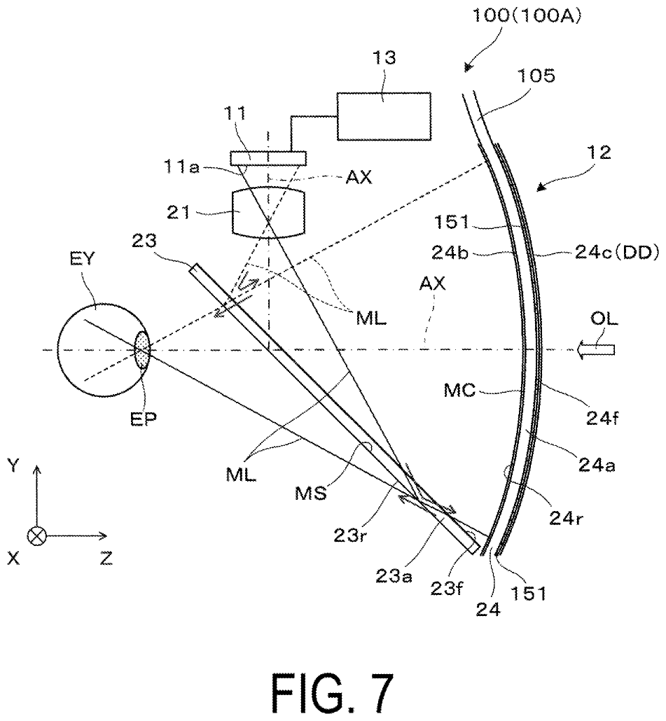

FIG. 8 is a side cross-sectional view illustrating a virtual image display device 100 of the third exemplary embodiment. In this case, the imaging light generation device 311 has a narrow band light source 311a and a scanner 311b. The narrow band light source 311a is specifically a laser light source, and the half width thereof is ±1 nm or less. Although detailed explanation is omitted, the narrow band light source 311a is obtained by synthesizing laser light from three RGB light sources with a dichroic mirror. The display control circuit 13 enables the RGB light emission timing to be turned on and off at high speed. The scanner 311b may be periodically tilted by rotating a mirror 15 back and forth about two axes in synchronization with the emission timing of the narrow band light source 311a under control of the display control circuit 13. The scanner 311b can control the reflection direction of the laser beam about the two axes. As a result, the imaging light ML emitted from the imaging light generation device 311 has an angle and intensity corresponding to the virtual image observed in the virtual image display device 100. The imaging light ML is scanned in two dimensions. The scanner 311b is also a portion of the optical unit 12.

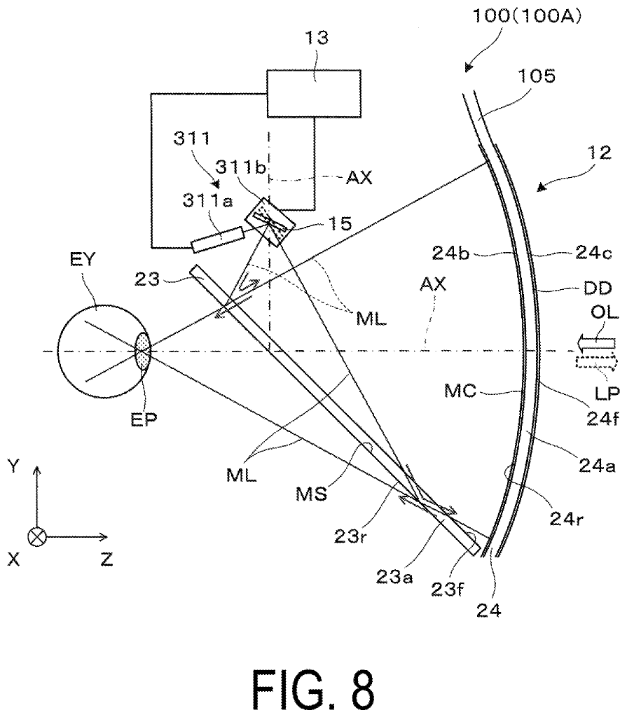

FIG. 9 is a schematic chart illustrating characteristics of the imaging light generation device 311 and functions of the reflection type diffraction element DD, corresponding to FIG. 3. In the example illustrated in FIG. 9, the wavelength characteristic W1 of the imaging light ML indicated by the solid line is the light emission characteristic of the imaging light generation device 311, and has little wavelength spread and has a peak value. The wavelength characteristic W2 of the reflection type diffraction element DD illustrated by the dot-dash line is the same as that illustrated in FIG. 3, and there is no change. Accordingly, the imaging light ML or passing light LP that finally passes through the concave transmission mirror 24 is almost zero and does not exist.

In the above, the narrow band light source 311a may be a narrow-band light source such as an LED. The scanner 311b may also rotate the two mirrors 15 about non-parallel axes. Furthermore, a relay lens for adjusting the state of the luminous flux or a pupil enlarging member for enlarging the luminous flux size of the imaging light ML can be disposed after the scanner 311B.

### Fourth Exemplary Embodiment

Hereinafter, a virtual image display device according to a fourth exemplary embodiment will be described. Note that the virtual image display device according the fourth exemplary embodiment is obtained by modifying a part of the virtual image display device according to the first exemplary embodiment, and description on common portions is omitted.

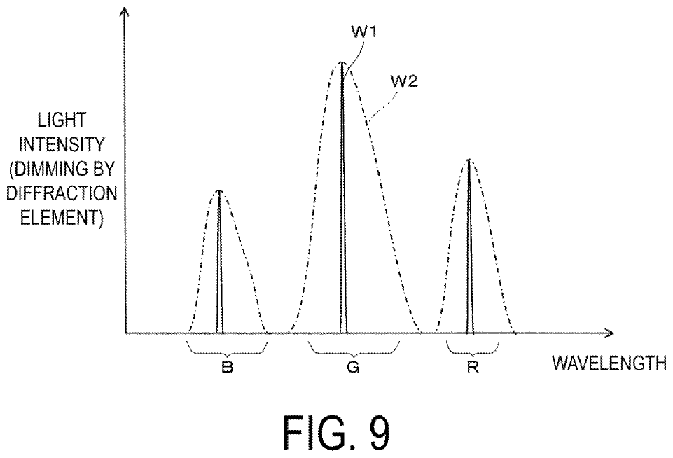

FIG. 10 is a side cross-sectional view illustrating a virtual image display device 100 of the fourth exemplary embodiment. In this case, the optical axis AX from the exit pupil EP through the transmission inclined mirror 23 toward the concave transmission mirror 24, that is, an exit optical axis AXE, extends inclinedly downward with a tilt angle δ=10° with respect to the forward +Z direction. The exit optical axis AXE is an axis derived from the shape symmetry of the concave transmission mirror 24. By setting the exit optical axis AXE downward to approximately 10° on the front side with respect to the Z-axis, which is the horizontal axis, the fatigue of the wearer US with the eye EY, observing the virtual image, can be reduced.

### Fifth Exemplary Embodiment

Hereinafter, a virtual image display device according to a fifth exemplary embodiment will be described. Note that the virtual image display device according the fifth exemplary embodiment is obtained by modifying a part of the virtual image display device according to the first exemplary embodiment, and description on common portions is omitted.

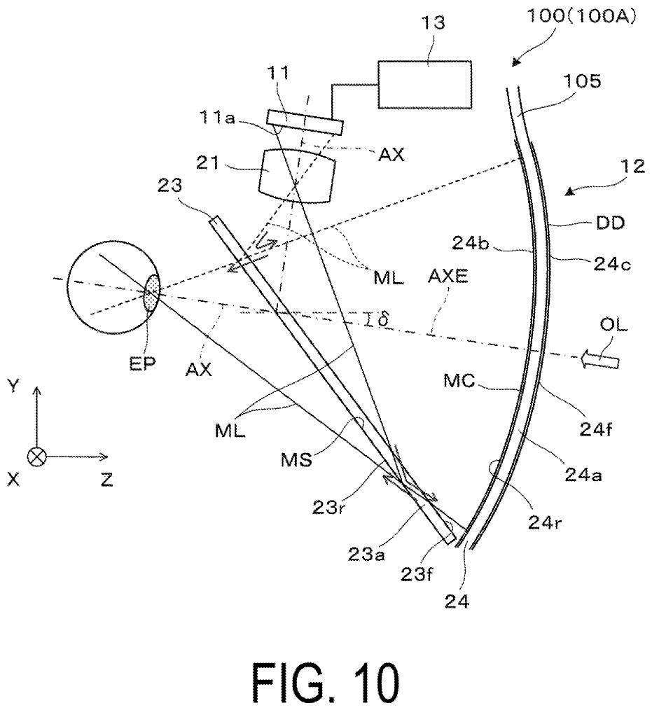

A virtual image display device according to the fifth exemplary embodiment will be described with reference to FIG. 11. The optical unit 512 includes the projection lens 21, a folding mirror 22, the transmission inclined mirror 23, and the concave transmission mirror 24. In other words, the folding mirror 22 is disposed between the projection lens 21 and the transmission inclined mirror 23.

The folding mirror 22 includes a first mirror 22a and a second mirror 22b in an optical path from the imaging light generation device 11. The folding mirror 22 reflects the imaging light ML from the projection lens 21 in the intersecting direction. The transmission inclined mirror 23 is disposed on the light exit side of the second mirror 22b. A projection optical axis AX0, which is an optical axis of the projection lens 21, extends parallel to the horizontal X-axis direction. The optical path is bent along the reflective optical axis AX1 from the projection optical axis AX0 by the first mirror 22a, and the optical path is bent along the reflective optical axis AX2 from the reflective optical axis AX1 by the second mirror 22b. As a result, the optical axis extending in a substantially horizontal direction on the exit side of the projection lens 21 extends in a direction close to the vertical at the incident side of the transmission inclined mirror 23.

The transmission inclined mirror 23 is inclined at an angle θ=20˜40° in a counterclockwise direction about the X axis when viewed from the −X side with respect to the XY plane extending in the vertical direction. The optical path from the imaging light generation device 11 to the folding mirror 22 is disposed on the upper side of the transmission inclined mirror 23. More specifically, the imaging light generation device 11, the projection lens 21, and the folding mirror 22 disposed in a space interposed between an inclined plane in which the transmission inclined mirror 23 is extended and a vertical surface in which an upper end of the concave transmission mirror 24 is extended upward.

As described above, the transmission inclined mirror 23 is inclined at an angle θ=20˜40° in a counterclockwise direction about the X axis when viewed from the −X side, based on the XY plane as described above. In other words, the transmission inclined mirror 23 is disposed so that the angle formed by the Y axis, which is the vertical axis, and the transmission inclined mirror 23, is less than 45°. If the angle formed by the Y axis and the transmission inclined mirror 23 is greater than 45°, the transmission inclined mirror 23 is in a state of being tipped more than the standard, and the thickness of the transmissive mirror in the Z-axis direction increases. Meanwhile when the angle formed by the Y axis and the transmission inclined mirror 23 is less than 45°, the transmission inclined mirror 23 is in a state of rising more than the standard, and the thickness of the transmissive mirror in the Z-axis direction decreases. In other words, by making the angle formed by the Y axis and the transmission inclined mirror 23 less than 45° as in the present exemplary embodiment, it is possible to avoid the transmission inclined mirror 23 from being disposed to protrude greatly in the −Z direction of the back surface with respect to the concave transmission mirror 24, whereby avoiding an increase in the thickness of the virtual image display device 100 or the optical unit 512 in the front-rear direction in the Z direction.

In the optical unit 512, the cross-sectional structure of the concave transmission mirror 24 is the same as that illustrated in FIGS. 2a and 2b. In addition, as in the second exemplary embodiment illustrated in FIG. 4, the cover 124 may be disposed at the front face of the concave transmission mirror 24, and the reflection type diffraction layer 24c, which is the reflection type diffraction element DD, can be formed at the cover 124 rather than the concave transmission mirror 24. In the optical unit 512, the wavelength-limiting filter 51 illustrated in FIG. 5 or the wavelength-limiting filter 151 illustrated in FIG. 7 can be incorporated. As in the imaging light generation device 311 illustrated in FIG. 8, the imaging light generation device 11 and the projection lens 21 can be replaced with one that consists of the narrowband light source 311a and the scanner 311b.

### Sixth Exemplary Embodiment

Hereinafter, a virtual image display device according to a sixth exemplary embodiment will be described. Note that the virtual image display device according the sixth exemplary embodiment is obtained by modifying a part of the virtual image display device according to the first exemplary embodiment, and description on common portions is omitted.

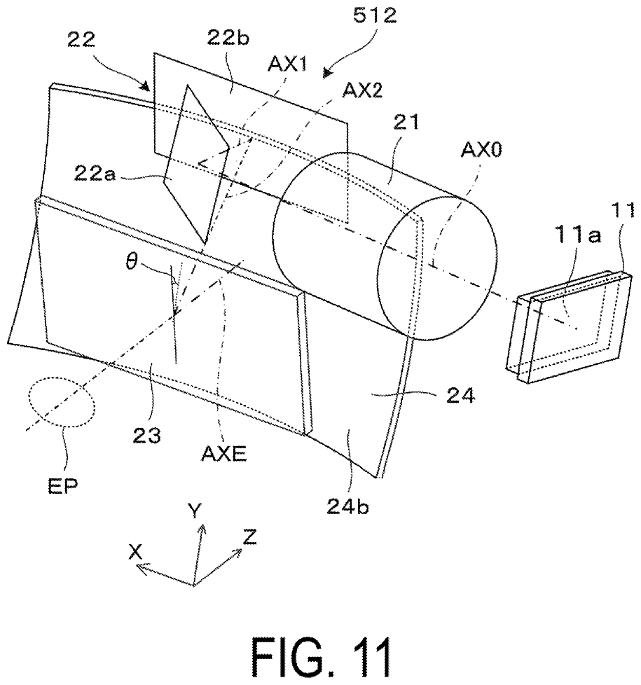

As illustrated in FIG. 12, an optical unit 612 includes the projection lens 21 and a light guide 612a. The light guide 612a is formed by joining a light-guiding member 31 and an optical transmission member 32 via an adhesive layer CC. The light-guiding member 31 and the optical transmission member 32 are formed from a resin material that exhibits high optical transparency in the visible region. The light-guiding member 31 has first to fifth surfaces S11 to S15, of which the first and third surfaces S11, S13 are flat surface parallel to one another. The second surface, the fourth surface, and the fifth surface S12, S14, S15 are all convex optical surfaces, and are constituted by free curved surfaces, for example. The light transmission member 32 includes first to third transmission surfaces S21 to S23, of which the first and third transmission surfaces S21 and S23 are flat surface parallel to one another. The second transmission surface S22 is a concave optical surface as a whole, and is constituted by a free curved surface, for example. The second surface S12 of the light-guiding member 31 and the second transmission surface S22 of the light transmission member 32 have an equal shape in which the recesses and protrusions thereof are inverted, and the partial reflection surface MC including a partial reflection film is formed at one of the two surfaces. The partial reflection surface MC is concave to the inside and convex to the external side. The portion of the light-guiding member 31 and the light transmission member 32 joined together across the partial reflection surface MC function as a concave transmission mirror 624, which has transparency and contributes to imaging. The concave transmission mirror 624 includes a reflection type diffraction layer 24c on a surface of the external side thereof. The reflection type diffraction layer 24c is disposed on the external side of the partial reflection surface MC, and functions as the reflection type diffraction element DD. Since the reflection type diffraction element DD diffracts the imaging light ML so that the imaging light ML is deviated from the optical path passing through the concave transmission mirror 624, the imaging light ML emitted to the external side through the partial reflection film 24b can be suppressed.

Hereinafter, an overview of the optical path of the imaging light ML will be described. The light-guiding member 31 guides the imaging light ML emitted from the projection lens 21 toward the observer's eyes by reflection on the first to fifth surfaces S11 to S15. Specifically, the imaging light ML from the projection lens 21 is first incident on the fourth surface S14 and reflected by the fifth surface S15, which is the inner surface of the reflection film RM. The imaging light ML is incident again from the inner side on the fourth surface S14 and is totally reflected. Then the imaging light ML is incident on and totally reflected by the third surface S13, and is incident on and totally reflected by the first surface S11. The imaging light ML totally reflected by the first surface S11 is incident on the second surface S12, is partially reflected while partially passing through the partial reflection surface MC, i.e. a partial reflection film, provided at the second surface S12. Then the imaging light ML is incident again on the first surface S11 and passes therethrough. The imaging light ML that has passed through the first surface S11 is incident on the exit pupil EP where the observer's eyes are located as a substantially parallel luminous flux. That is, the observer observes the image by the imaging light ML as a virtual image.

The optical unit 612 causes the observer visually recognize the imaging light ML by the light-guiding member 31, and causes the observer to observe the external image with little distortion in a state where the light-guiding member 31 and the light transmission member 32 are combined. At this time, since the third surface S13 and the first surface S11 are flat surfaces substantially parallel to each other (diopter is approximately 0), almost no aberration etc. occurs in the external light OL. Further, similarly, the third transmission surface 23 and the first transmission surface S21 are flat surfaces that are substantially parallel to each other. Furthermore, since the third transmission surface S23 and the first surface S11 are flat surfaces that are substantially parallel to each other, almost no aberration etc. occurs. As described above, the observer observes the external image without distortion through the light transmission member 32.

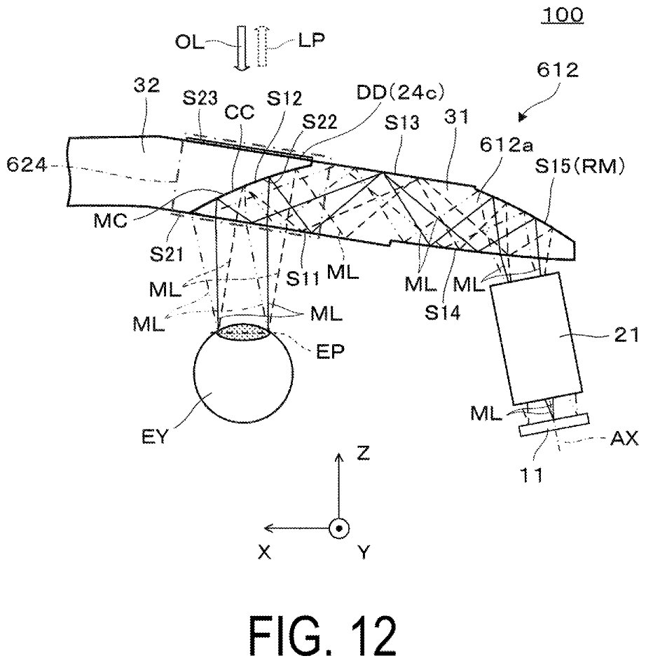

FIG. 13 is a diagram illustrating a modification example of the virtual image display device 100 shown in FIG. 12. In this case, the cover 124 is detachably fixed to the external side of the optical unit 612 or the light guide 612a. The cover 124 has a similar structure to that illustrated in FIG. 4 and has a reflection type diffraction layer 24c as the reflection type diffraction element DD. Since the reflection type diffraction element DD diffracts the imaging light ML so that the imaging light ML is deviated from the optical path passing through the concave transmission mirror 624, the imaging light ML emitted to the external side through the partial reflection film 24b can be suppressed.

### Seventh Exemplary Embodiment

Hereinafter, a virtual image display device according to a seventh exemplary embodiment will be described. Note that the virtual image display device according the seventh exemplary embodiment is obtained by modifying a part of the virtual image display device according to the first exemplary embodiment, and description on common portions is omitted.

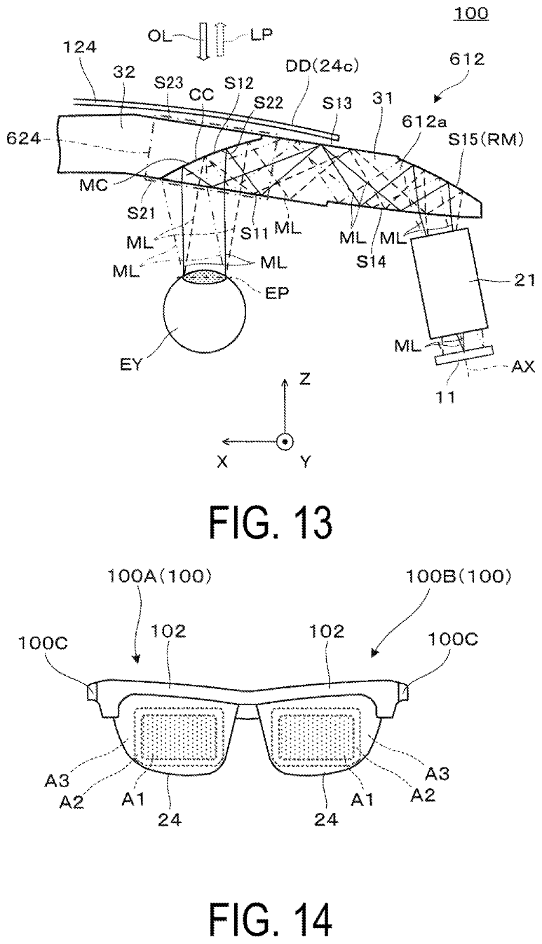

Referring to FIG. 14, in the present exemplary embodiment, the partial reflection surface MC and the reflection diffraction element DD can be formed in a localized effective region A1 of the concave transmission mirror 24 or the appearance member 105. For regions A2, A3 around the effective region A1, a reflectance transition region can be formed with gradually decreasing the reflectance of the imaging light ML with respect to the partial reflection surface MC. Thus a transition region in which the diffraction efficiency of the imaging light ML gradually decreases with respect to the reflection diffraction element DD can be formed. Note that, as illustrated in FIG. 4, when the cover 124 is provided covering the concave transmission mirror 24, it is sufficient that the cover 124 is formed in a region covering the effective region A1. Note that when the cover 124 entirely covers the external side of the concave transmission mirror 24, the reflection diffraction element DD can be formed in a region of the cover 124 that covers the effective region A1 of the concave transmission mirror 24 with respect to the line-of-sight direction with respect to the exit pupil EP reference.

### MODIFICATION EXAMPLES AND OTHERS

The present disclosure is described according to the above-mentioned exemplary embodiments, but the present disclosure is not limited to the above-mentioned exemplary embodiments. The present disclosure may be carried out in various modes without departing from the gist of the present disclosure, and, for example, the following modifications may be carried out.

The optical unit 12 can be an optical system that does not include the projection lens 21. In this case, the optical system collimates the display image formed at the display surface 11a of the imaging light generation device 11 by the concave transmission mirror 24.

The plate shaped body 24a that constitutes the concave transmission mirror 24 is not limited to a resin material, and may be formed from glass, synthetic quartz, or a composite of these material and a resin material.

The optical unit 12 may be an optical system including a light guide, a prism, a composite of a prism and a mirror, etc. before the transmission inclined mirror 23.

A virtual image display device according to a specific aspect includes an imaging light generation device, and an optical unit including a concave transmission mirror provided with a partial reflection film, the optical unit being configured to form a virtual image with the imaging light emitted from the imaging light generation device, wherein the optical unit includes a reflection type diffraction element disposed on an external side of the partial reflection film, the reflection type diffraction element being configured to diffract the imaging light so that the imaging light is deviated from an optical path passing through the concave transmission mirror.

In the above-described virtual image display device, the reflection type diffraction element diffracts the imaging light so that the imaging light is deviated from the optical path passing through the concave transmission mirror, whereby the imaging light emitted to the external side through the partial reflection film can be suppressed, and the image in the display is made less visible from the outside, and the effect of suppressing information loss increases.

In a specific aspect, the reflection type diffraction element diffracts the imaging light upward or downward. A situation where the third party is present above or below the virtual image display device is unlikely to occur, and the light shielding member is easily disposed above or below the virtual image display device 100, whereby the effect of suppressing information loss can be further enhanced.

In another aspect, the reflection type diffraction element is formed as part of the concave transmission mirror on the surface on an external side of the concave transmission mirror. In this case, a number of parts can be reduced and an increase in the weight and price of the device can be suppressed.

In yet another aspect, the reflection type diffraction element is formed at the cover disposed on the external side of the concave transmission mirror. In this case, manufacturing and incorporation of the reflection type diffraction element is facilitated.

In yet another aspect, the cover has transparency to the external light between the wavelength ranges of respective colors of the imaging light.

In yet another aspect, the cover is formed in a region covering an effective region of the concave transmission mirror.

In yet another aspect, the reflection type diffraction element is the volume hologram element. The volume hologram element is highly controllable to the imaging light and has a high degree of freedom in design for the transparency of the external light.

In yet another aspect, the volume hologram element includes the three volume hologram layers corresponding to the three colors. In this case, the diffraction efficiency for each three colors can be increased, whereby the effect of suppressing passing light emitted to the external side through the concave transmission mirror is enhanced.

In yet another aspect, the reflection type diffraction element includes a the wavelength-limiting filter that modifies the wavelength distribution of the imaging light in accordance with the wavelength characteristics of the reflection type diffraction element. In this case, the characteristics of the imaging light incident on the wavelength-limiting filter are easily matched to the diffraction characteristics of the reflection type diffraction element, whereby the reliability of preventing information loss is enhanced.

In yet another aspect, the wavelength-limiting filter is provided in association with the imaging light generation device. In this case, since the external light is not attenuated by the wavelength-limiting filter, it is possible to suppress a decrease in see-through properties.

In yet another aspect, the wavelength-limiting filter is disposed between the substrate and the reflection type diffraction element in the concave transmission mirror.

In yet another aspect, the imaging light generation device includes the light source that emits the narrow band light.

In yet another aspect, the imaging light generation device includes the scanner that scans the laser light emitted from a laser source that is the light source.

In yet another aspect, the concave transmission mirror reflects the imaging light to collect the imaging light into the exit pupil.

In yet another aspect, the optical unit includes the transmission inclined mirror that reflects the imaging light from the imaging light generation device, and the concave transmission mirror reflects the imaging light reflected by the transmission inclined mirror toward the transmission inclined mirror. In this case, the transmission inclined mirror is disposed covering the front of the eye, and the concave transmission mirror is disposed covering the transmission inclined mirror.

An optical unit according to a specific aspect including a concave transmission mirror provided with a partial reflection film, the optical unit being configured to form a virtual image with imaging light, the optical unit includes a reflection type diffraction element disposed on an external side of the partial reflection film, the reflection type diffraction element being configured to diffract the imaging light so that the imaging light is deviated from an optical path passing through the concave transmission mirror.

What is claimed is:

1. A virtual image display device comprising:
an imaging light generation device; and
an optical unit including a concave transmission mirror provided with a partial reflection film, the optical unit being configured to form a virtual image with the imaging light emitted from the imaging light generation device, wherein
the optical unit includes a reflection type diffraction element disposed on an external side of the partial reflection film, the reflection type diffraction element being configured to diffract the imaging light so that the imaging light is deviated from an optical path passing through the concave transmission mirror.

2. The virtual image display device according to claim 1, wherein
the reflection type diffraction element is configured to diffract imaging light upward or downward.

3. The virtual image display device according to claim 1, wherein
the reflection type diffraction element is formed, as part of the concave transmission mirror, at a surface on an external side of the concave transmission mirror.

4. The virtual image display device according to claim 1, wherein
the reflection type diffraction element is formed at a cover disposed on an external side of the concave transmission mirror.

5. The virtual image display device according to claim 4, wherein
the cover has transparency to external light between wavelength ranges of respective colors of the imaging light.

6. The virtual image display device according to claim 4, wherein
the cover is formed in a region covering an effective region of the concave transmission mirror.

7. The virtual image display device according to claim 1, wherein
the reflection type diffraction element is a volume hologram element.

8. The virtual image display device according to claim 7, wherein
the volume hologram element includes three volume hologram layers corresponding to three colors.

9. The virtual image display device according to claim 1, wherein
the reflection type diffraction element includes a wavelength-limiting filter configured to modify a wavelength distribution of the imaging light in accordance with a wavelength characteristic of the reflection type diffraction element.

10. The virtual image display device according to claim 9, wherein
the wavelength-limiting filter is provided in association with the imaging light generation device.

11. The virtual image display device according to claim 9, wherein
the wavelength-limiting filter is disposed between a substrate and the reflection type diffraction element in the concave transmission mirror.

12. The virtual image display device according to claim 1, wherein
the imaging light generation device includes a light source configured to emit narrow band light.

13. The virtual image display device according to claim 12, wherein
the imaging light generation device includes a scanner configured to scan laser light emitted from a laser light source that is the light source.

14. The virtual image display device according to claim 1, wherein
the concave transmission mirror is configured to reflect the imaging light to collect the imaging light into an exit pupil.

15. The virtual image display device according to claim 1, wherein
the optical unit includes a transmission inclined mirror configured to reflect imaging light from the imaging light generation device, and
the concave transmission mirror is configured to reflect imaging light reflected by the transmission inclined mirror toward the transmission inclined mirror.

16. An optical unit including a concave transmission mirror provided with a partial reflection film, the optical unit being configured to form a virtual image with imaging light, the optical unit comprising
a reflection type diffraction element disposed on an external side of the partial reflection film, the reflection type diffraction element being configured to diffract the imaging light so that the imaging light is deviated from an optical path passing through the concave transmission mirror.
